(19) United States
(12) Patent Application Publication
(10) Pub. No.: US 2004/0149254 A1
(43) Pub. Date: Aug. 5, 2004

(54) Method for operating an internal combustion engine operated with gas

(76) Inventor: Walter Piock, Hitzendorf (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/738,211

(22) Filed: Dec. 18, 2003

(30) Foreign Application Priority Data
Dec. 19, 2002 (AT) GM 856/2002

(51) Int. Cl. F02B 17/00; F02B 43/00

(52) U.S. Cl. 123/295; 123/527

(57) ABSTRACT

The invention relates to a method for operating a gas-operated internal combustion engine, with the gas being injected into the combustion chamber by way of an injection apparatus and a stratified charge being produced. A fuel gas, preferably natural gas, hydrogen or a mixture of combustible gases, is injected into a chamber which is separated from the combustion chamber and can be connected with the same by means of a switchable valve and is mixed with a second gas, and that said gas mixture is injected directly into the combustion chamber by opening the switchable valve.

### BACKGROUND OF THE INVENTION

The invention relates to a method for operating an internal combustion engine operated with gas, with the gas being injected into the combustion chamber by way of an injection apparatus and a stratified charge being produced. The invention further relates to a gas-driven internal combustion engine with at least one high-pressure gas accumulator, with at least one injection apparatus per cylinder and a distributor line between high-pressure gas accumulator and injection apparatus, as well as a pressure controller arranged between the high-pressure accumulator and the distributor line, with the injection apparatus comprising a chamber which can be connected with the combustion chamber by way of a switchable valve, preferably a reciprocating valve, and into which opens a gas supply line starting out from the distributor line.

U.S. Pat. No. 4,574,754 A1 discloses an internal combustion engine for gaseous fuel, in which the gas is injected into the internal combustion engine in such a way that a stratified charge is obtained. In comparison with gas-driven internal combustion engines with homogeneous mixture preparation, a more complete combustion of the combustion gas can be achieved by the oxygen-rich environment in the combustion chamber, which has an advantageous effect on emissions and efficiency. The disadvantageous aspect is however that in the case of such turbulence-controlled charge stratifications the ignition range is configured in a relatively narrow fashion, as a result of which it is only possible to achieve a relatively low ignition stability.

Further gas-driven internal combustion engines with gas injection directly into the combustion chamber are known from U.S. Pat. No. 5,329,908 A and U.S. Pat. No. 5,941,210 A.

In the case of internal combustion engines which are operated with liquid fuel, it is further known to perform an air-supported injection of the fuel into the combustion chamber. U.S. Pat. No. 6,161,527 A for example shows such an air-supported fuel injection system in which fuel is pre-mixed with air and said mixture is injected into the combustion chamber by way of a controlled valve. AT 407.559 B describes a device for introducing fuel into the combustion chamber of an internal combustion engine, with which gas is taken from the combustion chamber during an operating cycle by way of a controlled reciprocating valve and is supplied to a chamber. The gas is intermediately stored in the chamber and fuel which is conveyed by a pump is injected into the gas. In the subsequent operating cycle the mixture of fuel and gas is injected into the combustion chamber. A charge stratification can thus be produced in the combustion chamber and the efficiency and the pollutant emissions can be improved in a simple and efficient way.

### SUMMARY OF THE INVENTION

It is the object of the present invention to avoid such disadvantages and to substantially reduce nitrogen oxide and hydrocarbon emissions in a gas-driven internal combustion engine.

This is achieved in accordance with the invention in such a way that a fuel gas, preferably natural gas, hydrogen or a mixture of combustible gases, is injected into a chamber which is separated from the combustion chamber and can be connected with the same by means of a switchable valve and is mixed with a second gas, and that said gas mixture is injected directly into the combustion chamber by opening the switchable valve. The gas mixture is injected preferably in a crank angle range of between 130° to 45° of crank angle before the upper dead center.

The fuel gas can be mixed in the chamber with air or with the gas taken from the combustion chamber.

The mixture with gas from the combustion chamber can occur in a simple manner in such a way that during an operating cycle a relatively small quantity (approx. 6 to 12 cm³) of compressed hot gas is taken from the combustion chamber and is stored in the chamber, that the fuel gas is injected into the hot gas and that the stored gas mixture is injected into the combustion chamber in the subsequent cycle.

An injection apparatus is suitable for performing the method with which a re-charging of gas taken from the combustion chamber into a chamber of the injection apparatus is enabled. In order to enable a metered supply of the fuel gas into the chamber it is advantageous to provide a control valve in the gas supply line.

The fuel gas is blown into the combustion chamber pre-mixed with air or gas taken from the combustion chamber. A stratified charge which is controlled by the injection is produced in the combustion chamber, which stratified charge has a very wide combustible mixture range. As a result of the high ignition stability it is possible to substantially reduce the hydrocarbon emissions. Since the engine is operated only in the very lean mixture range, only very low NOₓ emissions are obtained.

The switchable valve of the injection apparatus can be actuated either mechanically, electrically, hydraulically or pneumatically.

### BRIEF DESCRIPTION OF THE DRAWINGS

The invention is now explained in closer detail by reference to the enclosed schematic drawings, wherein:

FIG. 1 shows the internal combustion engine, and

FIG. 2 shows a cylinder of said internal combustion engine.

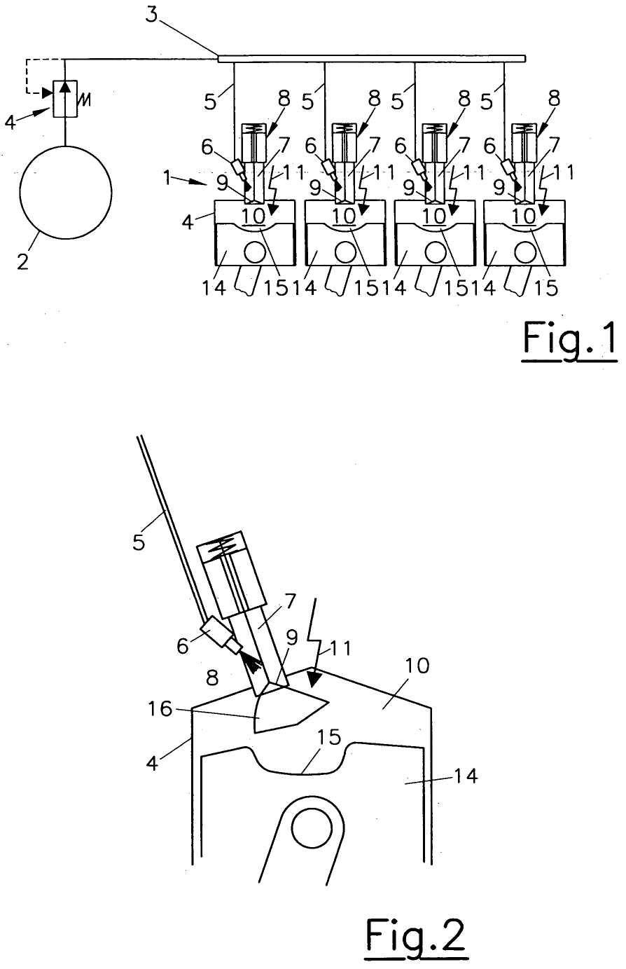

### DETAILED DESCRIPTION OF THE PREFERRED EMBODIMENT

The gas-driven internal combustion engine 1 comprises a high-pressure accumulator 2 for the fuel gas which can be natural gas, hydrogen, a mixture of combustible gases or the like. A distributor line 3 starts out from the high-pressure accumulator 2, with a pressure controller 4 being arranged between distributor line 3 and high-pressure accumulator 2, which pressure controller reduces the fuel gas under a pressure of approximately 200 bars in the high-pressure accumulator 2 to a supply pressure of approximately 6 bars for example. At least one gas supply line 5 starts out from the supply line 3 for each cylinder 4, which gas supply line opens into a chamber 7 of an injection device 8 via a control valve 6. The chamber 7 is connected with the combustion chamber of a cylinder 4 via a switchable valve 9, preferably a reciprocating valve. The valve 9 can be actuated either hydraulically, pneumatically, mechanically or electrically.

An ignition device opening into the combustion chamber 10 is designated with reference numeral 11.

Reference numeral 14 designates a piston reciprocating in cylinder 4 and comprising a piston trough 15.

The chamber 7 of the injection apparatus 8 is used as a pre-mixing chamber and as a gas accumulator. The fuel gas is injected directly into the chamber 7 via the control valve 6. If the thorough mixture of the fuel gas with the gas taken previously from the combustion chamber, the injection apparatus 8 per se removes a relatively small quantity of approximately 6 to 12 cm³ (size of chamber 7) of compressed hot gas from the combustion chamber 10 during an operating cycle, such that the valve 9 is kept open for a respectively long period after the termination of the injection process into the combustion chamber 10. Such gas taken from the combustion chamber 10 is intermediately stored in the chamber 7 and the fuel gas is then injected via the control valve 6 into the gas stored in the chamber 7. In the subsequent cycle the mixture of fuel gas and gas taken from the combustion chamber 10 is injected into the combustion chamber 10, thus leading to a stratified charge 16 in the combustion chamber 10. The gas mixture injected into the combustion chamber 10 has a local air ratio of between 1 and 1.7. As a result of the high combustible lean mixture range it is possible to reduce both the NOₓ emissions as well as hydrocarbon emissions.

What is claimed is:

1. A method for operating a gas-operated internal combustion engine, with the gas being injected into a combustion chamber by way of an injection apparatus and a stratified charge being produced, wherein a fuel gas is injected into a chamber which is separated from the combustion chamber and can be connected with the same by means of a switchable valve and is mixed with a second gas, and wherein said gas mixture is injected directly into the combustion chamber by opening the switchable valve.

2. The method according to claim 1, wherein the fuel gas is selected from the group natural gas, hydrogen and a mixture of combustible gases.

3. The method according to claim 1, wherein the gas mixture is injected into the combustion chamber in a crank angle range of between approximately 130° to 45°.

4. The method according to claim 1, wherein the fuel gas is mixed with air.

5. The method according to claim 1, wherein the fuel gas is mixed with a gas taken previously from the combustion chamber.

6. The method according to claim 5, wherein during an operating cycle a relatively small quantity (approx. 6 to 12 cm³) of compressed hot gas is taken from the combustion chamber and is stored in the chamber, wherein the fuel gas is injected into the hot gas and wherein the stored gas mixture is injected into the combustion chamber in the subsequent cycle.

7. A gas-driven internal combustion engine with at least one high-pressure gas accumulator, with at least one injection apparatus per cylinder and a distributor line between the high-pressure gas accumulator and injection apparatus, as well as a pressure controller arranged between the high-pressure accumulator and the distributor line, with the injection apparatus comprising a chamber which can be connected with a combustion chamber by way of a switchable valve and into which opens a gas supply line starting out from the distributor line, wherein a control valve is arranged in the gas supply line.
